(19) United States
(12) Patent Application Publication
(10) Pub. No.: US 2026/0058892 A1
(43) Pub. Date: Feb. 26, 2026

(54) COMMUNICATION SYSTEM, CONTROLLER, COMMUNICATION PROCESSING DEVICE, AND METHOD FOR CONTROLLING COMMUNICATION SYSTEM

(71) Applicant: ICOM INCORPORATED, Osaka (JP)

(72) Inventor: Satoshi MATSUDA, Osaka (JP)

(21) Appl. No.: 19/304,874

(22) Filed: Aug. 20, 2025

(30) Foreign Application Priority Data
Aug. 23, 2024 (JP) 2024-143465

(51) Int. Cl. H04L 43/0811

(52) U.S. Cl. CPC H04L 43/0811

(57) ABSTRACT

A radio communication system includes a radio processing device and a controller. The radio processing device includes a second communication control section performing communication with the controller. The controller includes a first communication control section which determines, after starting communication with the radio processing device, whether connection with the radio processing device is direct connection by a communication cable or connection via a home LAN and which performs a process according to a determination result.

### CROSS-REFERENCE TO RELATED APPLICATIONS

This Nonprovisional application claims priority under 35 U.S. C. § 119 on Patent Application No. 2024-143465 filed in Japan on Aug. 23, 2024, the entire contents of which are hereby incorporated by reference.

### TECHNICAL FIELD

The present disclosure relates to a communication system, a controller, a communication processing device, and a method for controlling the communication system.

### BACKGROUND ART

In a conventionally used communication system, such as the one disclosed in, e.g., Patent Literature 1, a radio device which includes a high frequency circuit located near an antenna and a controller which controls the radio device are connected with each other via a LAN cable.

### CITATION LIST

### Patent Literature

### [Patent Literature 1]

Japanese Patent Application Publication, Tokukai, No. 2024-083706

### [Patent Literature 2]

Japanese Patent Application Publication, Tokukaihei, No. 4-278750 (1992)

### SUMMARY OF INVENTION

### Technical Problem

In the communication system described above, the radio device and the controller are directly connected with each other via the LAN cable. However, this communication system does not take into consideration a mode in which the radio device and the controller are connected with each other via a communication network, and thus cannot take into consideration a problem that may occur when the radio device and the controller are connected with each other via the communication network.

Patent Literature 2 discloses a method for carrying out remote control of a power source of a LAN terminal. According to this method, the power source of the terminal can be turned on or off by remote control carried out in another terminal on the LAN network. However, Patent Literature 2 also does not disclose a method for executing operation differently depending on whether the connection between the terminals is direct connection or connection made via a communication network.

An aspect of the present invention has an object to provide a communication system in which a controller and a communication processing device are separated from each other and which automatically changes process content depending on whether connection between the controller and the communication processing device is direct connection made by a communication cable or connection made via a communication network, thereby enabling a user to use the communication system even without carrying out setting operation.

### Solution to Problem

In order to solve the above object, a communication system in accordance with an aspect of the present disclosure includes: a communication processing device; and a controller which is communicably connected with the communication processing device, the controller being configured to control operation of the communication processing device. The communication processing device includes a second communication control section configured to carry out communication with the controller. The controller includes a first communication control section configured (a) to determine, after the controller starts communication with the communication processing device, whether the connection between the controller and the communication processing device is direct connection made by a communication cable or connection made via a communication network and (b) to carry out a process according to a result of the determination.

A method, in accordance with an aspect of the present disclosure, for controlling a communication system is a method for controlling a communication system which includes a communication processing device and a controller which is communicably connected with the communication processing device, the controller being configured to control operation of the communication processing device, the control method including: a determination step of determining, after the controller starts communication with the communication processing device, whether the connection between the controller and the communication processing device is direct connection made by a communication cable or connection made via a communication network; and a control step of carrying out a process according to a result of the determination made in the determination step.

### Advantageous Effects of Invention

In accordance with an aspect of the present disclosure, a communication system is configured such that a controller and a communication processing device are separated from each other, and automatically changes process content depending on whether connection between the controller and the communication processing device is direct connection made by a communication cable or connection made via a communication network, thereby enabling a user to use the communication system even without carrying out setting operation.

### BRIEF DESCRIPTION OF DRAWINGS

FIG. 1 is a block diagram illustrating a state in which a controller and a radio processing device in a radio communication system in accordance with an embodiment of the present disclosure are directly connected with each other via a first communication connector.

FIG. 2 is a sequence diagram illustrating a pairing process carried out in a case where the controller and the radio processing device in the radio communication system in accordance with the embodiment are directly connected with each other via the first communication connector.

FIG. 3 is a block diagram illustrating a case where the controller and the radio processing device in the radio communication system in accordance with the embodiment are directly connected with each other via the first communication connector and a second communication connector is connected with a home LAN.

FIG. 4 is a block diagram illustrating a case where the controller and the radio processing device in the radio communication system in accordance with the embodiment are connected with each other via the home LAN.

FIG. 5 is a sequence diagram illustrating an authentication process carried out in a case where the controller and the radio processing device in accordance with the embodiment are connected with the home LAN via the second communication connector.

### DESCRIPTION OF EMBODIMENTS

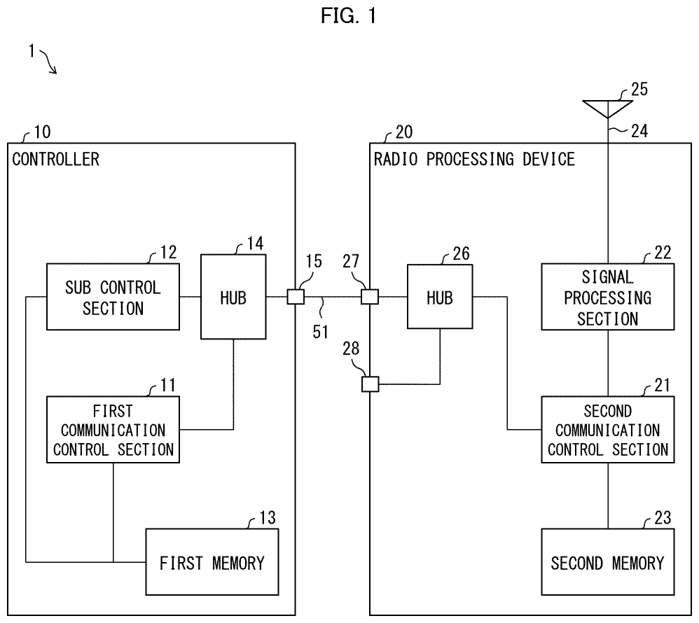

The following description will discuss, with reference to FIGS. 1 to 5, a radio communication system 1 in accordance with an embodiment of the present disclosure.

### Schematic Configuration of Radio Communication System

The following description will discuss, with reference to FIG. 1, a schematic configuration of the radio communication system 1. FIG. 1 is a block diagram illustrating a state in which a controller 10 and a radio processing device 20 in the radio communication system 1 are directly connected with each other via a first communication connector 27 of the radio processing device 20.

As shown in FIG. 1, the radio communication system 1 includes the controller 10 and the radio processing device 20. The radio communication system 1 carries out radio communication in, for example, a high frequency (HF) band or a very high frequency (VHF) band. The radio communication system 1 is one example of a communication system.

### Configuration of Controller

As shown in FIG. 1, the controller 10 includes a first communication control section 11, a sub control section 12, a first memory 13, a hub 14, and a communication connector 15. The controller 10 is a device for controlling operation of the radio processing device 20. In the present embodiment, the controller 10 includes two control sections, specifically, the first communication control section 11 and the sub control section 12. However, this is not limitative. Alternatively, the controller 10 may include one control section and may not include the hub 14.

Thanks to the configuration in which the controller 10 and the radio processing device 20 are provided as separate members, it is possible to dispose the radio processing device 20 at a given location suitable for reception of a radio wave and/or to dispose the controller 10 at a location corresponding to a place where a user wishes to use the controller 10, for example.

The first communication control section 11 controls communication via the communication connector 15, by executing a computing process by, e.g., a central processing unit (CPU). Meanwhile, the sub control section 12 carries out audio processing and/or the like with respect to audio data which is transmitted or received through communication, by executing a computing process by, e.g., a CPU. The first communication control section 11 and the sub control section 12 are connected with the communication connector 15 via the hub 14. The communication connector 15 is a connector which is to be used to make connection with a communication cable 51.

The first memory 13 is a nonvolatile memory such as an EEPROM. In the first memory 13, information such as a serial number of the controller 10, a serial number of the radio processing device 20, a public key, and/or a secret key is stored (details thereof will be described later).

Although not illustrated, the controller 10 is connected with a speaker, a microphone, and/or the like, each of which serves as an input-output device. The speaker outputs audio on the basis of audio data having been received from the radio processing device 20 and having been processed by the controller 10. The microphone converts user's voice into an audio signal, and inputs the audio signal into the controller 10. The controller 10 carries out, by the sub control section 12, audio processing with respect to the audio signal supplied through the microphone. Then, the controller 10 transmits, to the radio processing device 20, the audio signal thus processed.

### Configuration of Radio Processing Device

As shown in FIG. 1, the radio processing device 20 includes a second communication control section 21, a signal processing section 22, a second memory 23, an antenna 25, a hub 26, a first communication connector 27, and a second communication connector 28. The radio processing device 20 is one example of a communication processing device.

The second communication control section 21 controls communication via the first communication connector 27 and the second communication connector 28, by executing a computing process by, e.g., a CPU. The signal processing section 22 processes a high frequency signal transmitted or received via the antenna 25.

The second memory 23 is a nonvolatile memory such as an EEPROM. In the second memory 23, information such as the serial number of the radio processing device 20, the serial number of the controller 10, and/or a public key is stored (details thereof will be described later). The antenna 25 is connected with the signal processing section 22 via a coaxial cable 24.

The first communication connector 27 is a communication connector which is to be used to make direct connection made by the communication cable 51. The second communication connector 28 is a communication connector which is to be used to make communication with an external communication device via the communication network.

### Pairing Process When Direct Connection is Made

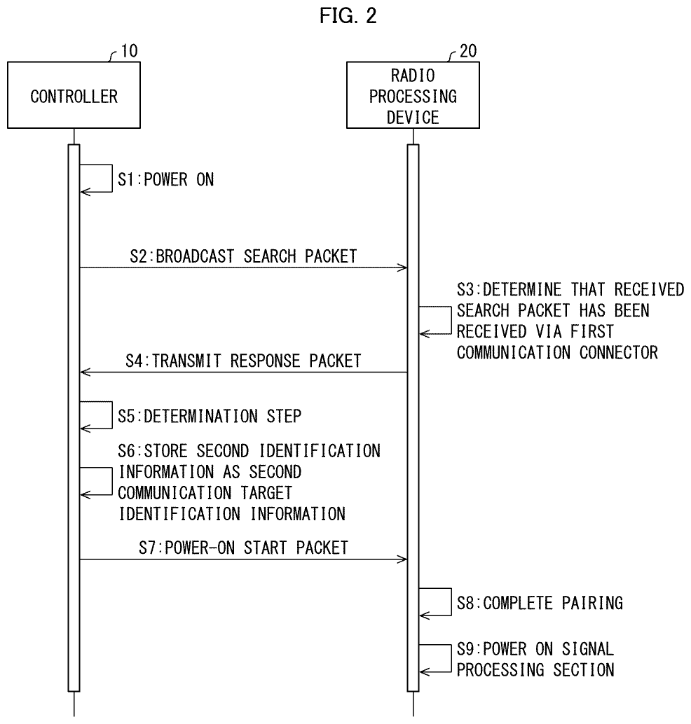

Next, the following description will discuss, with reference to FIG. 2, a pairing process between the controller 10 and the radio processing device 20 in the radio communication system 1. FIG. 2 is a sequence diagram illustrating the pairing process carried out when the controller 10 and the radio processing device 20 in the radio communication system 1 are directly connected with each other by the communication cable 51 via the first communication connector 27 of the radio processing device 20.

First, in order to start use of the radio communication system 1, the user makes direct connection between the communication connector 15 of the controller 10 and the first communication connector 27 of the radio processing device 20 by the communication cable 51.

Referring to the sequence diagram shown in FIG. 2, the user then powers on the controller 10 (sequence S1). During this, the radio processing device 20 is on standby in a state where the radio processing device 20 is communicable with the controller 10 (a) with power being supplied to the second communication control section 21, which consumes less power than the signal processing section 22, and (b) with no power being supplied to the signal processing section 22.

After sequence S1, the controller 10 broadcasts, via the communication cable connected with the communication connector 15, a search packet which requires a response from the radio processing device 20 (sequence S2). It is assumed that communication between the controller 10 and the radio processing device 20 in the pairing process is carried out in accordance with a user datagram protocol (UDP). However, this is not limitative. The search packet includes the serial number of the controller 10. The serial number corresponds to first identification information, which is identification information of the controller 10.

In sequence S3, the second communication control section 21 of the radio processing device 20 determines that the search packet received from the controller 10 has been received via the first communication connector 27.

After sequence S3, the second communication control section 21 transmits a response packet as a response to the search packet (sequence S4). The response packet includes connection information indicating that the search packet has been received via the first communication connector 27.

The response packet includes second identification information, which is identification information of the radio processing device 20, and a random character string. The random character string is generated by the second communication control section 21. Note that the random character string is changed every time the second communication control section 21 is powered on.

After sequence S4, the first communication control section 11 of the controller 10 receives the response packet from the radio processing device 20, and determines, on the basis of the connection information included in the received response packet, whether the connection is made via the first communication connector 27 or via the second communication connector 28 (sequence S5: determination step).

Then, in a case where the response packet includes the connection information indicating that the connection is made via the first communication connector 27, the first communication control section 11 stores, in the first memory 13, the second identification information included in the response packet, as second identification information of a communication target (hereinafter, such information will be referred to as “second communication target identification information”) indicative of a radio processing device which is the communication target (hereinafter, such a radio processing device will be referred to as a “communication target radio processing device”) (sequence S6).

After sequence S6, the first communication control section 11 transmits a power-ON start packet to the radio processing device 20 (sequence S7). The power-ON start packet includes the serial number of the controller 10, data obtained by encrypting a hash value of the random character string with the secret key, and the public key stored in the first memory 13. The secret key and the public key may be stored in the first memory 13 in advance. Alternatively, the secret key and the public key may be generated by the first communication control section 11 when the control section 10 is powered on.

After sequence S7, the second communication control section 21 receives the power-ON start packet, and decrypts the encrypted hash value with the received public key. Then, the second communication control section 21 compares the decrypted hash value with the hash value of the random character string generated by the second communication control section 21. If these two hash values are identical to each other, the pairing process is completed (sequence S8). Then, the second communication control section 21 stores, as the information of the controller 10 having been paired, the received serial number and public key of the controller 10 in the second memory 23 in such a manner that the serial number and the public key are associated with each other.

After sequence S8, in a case where it is confirmed that the radio processing device 20 is the communication target as a result of the pairing process, the second communication control section 21 transmits, to the radio processing device 20, an instruction to bring the signal processing section 22 into a state in which power is supplied to the signal processing section 22, so that the signal processing section 22 is powered on (sequence S9). Note that sequences S6 to S9 correspond to a control step, which carries out a process in accordance with a determination result obtained in the determination step.

When the signal processing section 22 is powered on, a process on a high frequency signal transmitted or received via the antenna 25 becomes ready to be carried out. This makes it possible for the controller 10 to control operation of the radio processing device 20 via the communication cable 51. Note here that communication between the first communication control section 11 of the controller 10 and the second communication control section 21 of the radio processing device 20 is carried out on the basis of a link local address.

As discussed above, in the radio processing device 20, powering on the controller 10 and carrying out the pairing process makes it possible to power on the signal processing section 22 remotely, even without carrying out a complicated setting.

### Internet Communication When Direct Connection is Made

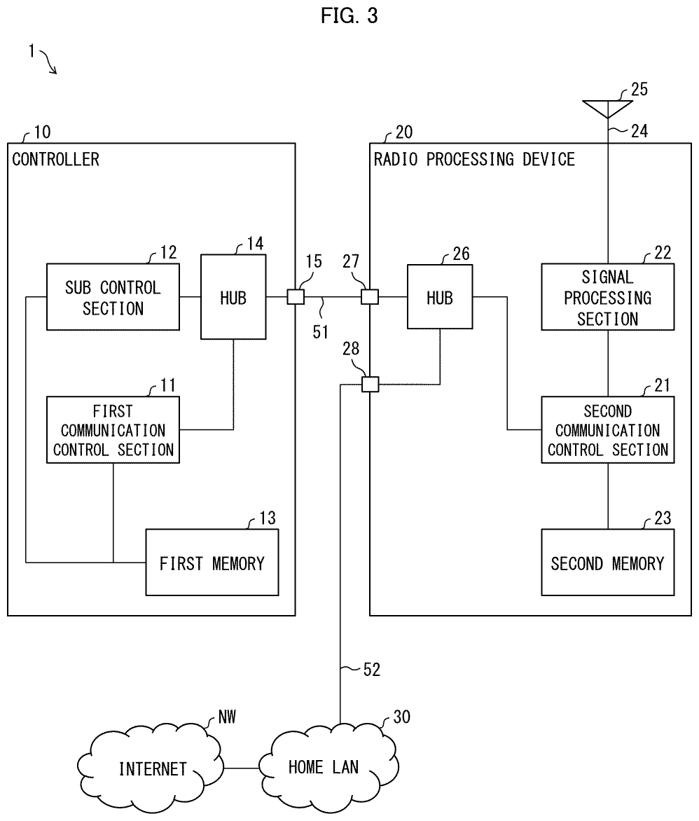

Next, the following description will discuss, with reference to FIG. 3, a case where, after the pairing process between the controller 10 and the radio processing device 20, the second communication connector 28 of the radio processing device 20 is connected with a home local area network (LAN) 30. FIG. 3 is a block diagram illustrating a state in which the controller 10 and the radio processing device 20 are directly connected with each other via the first communication connector 27 of the radio processing device 20 and the second communication connector 28 is connected with the home LAN 30.

As shown in FIG. 3, the communication connector 15 of the controller 10 and the first communication connect or 27 of the radio processing device 20 are directly connected with each other by the communication cable 51. Further, the second communication connector 28 of the radio processing device 20 is connected with the home LAN 30 via the communication cable 52. The home LAN 30 is connected with the Internet NW.

The first communication control section 11 of the controller 10 first carries out communication with the radio processing device 20 by using the link local address, and obtains an IP address from a dynamic host configuration protocol (DHCP) server (not illustrated) existing in the home LAN 30. Then, the controller 10 carries out communication by using the received IP address, and consequently can carry out communication with a device in the home LAN 30 and communication over the Internet NW.

As a result, the controller 10 can obtain time information from a network time protocol (NTP) server, and can operate in accordance with remote control carried out by an external terminal in which software for remote control of the controller 10 is installed.

In a case where no DHCP server exists in the home LAN, setting and inputting of the IP address may be carried out manually, so as to enable communication in the home LAN 30 and communication over the Internet NW.

### Authentication Process during Connection via Home LAN

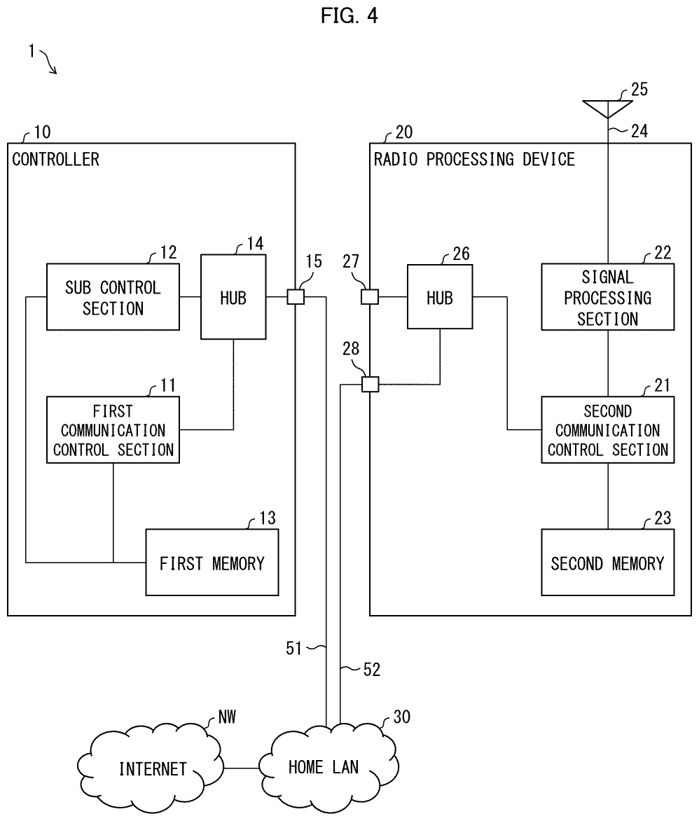

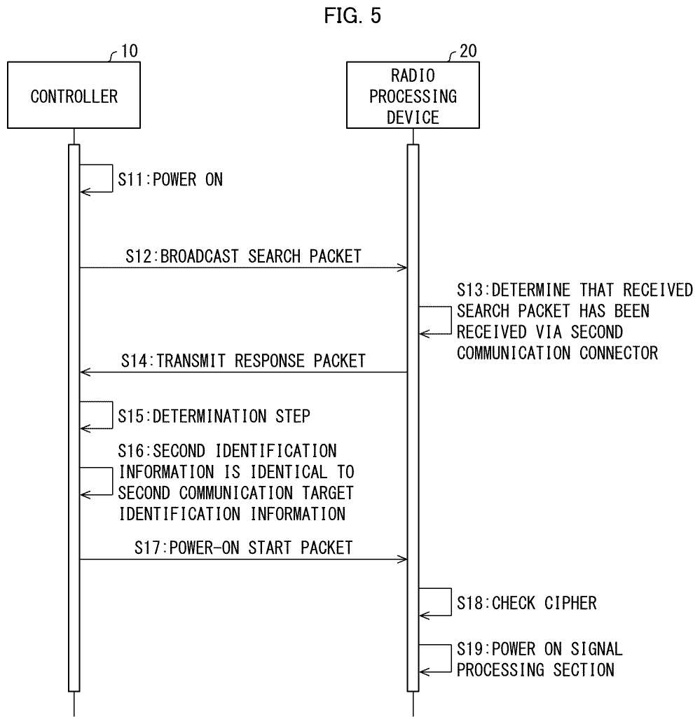

Next, the following description will discuss, with reference to FIGS. 4 and 5, an authentication process carried out when the controller 10 and the radio processing device 20 are connected with each other via the home LAN 30. FIG. 4 is a block diagram illustrating a case where the controller 10 and the radio processing device 20 are connected with each other via the home LAN 30.

As shown in FIG. 4, the communication connector 15 of the controller 10 is connected with the home LAN 30 via the communication cable 51. Further, the second communication connector 28 of the radio processing device 20 is connected with the home LAN 30 via the communication cable 52. Note that the controller 10 and the radio processing device 20 may be communicably connected with the home LAN 30 through radio communication via a radio LAN and/or the like.

That is, the radio processing device 20 is connected with the controller 10 via the home LAN 30. The home LAN 30 is one example of a communication network.

FIG. 5 is a sequence diagram illustrating the authentication process carried out when the controller 10 and the radio processing device 20 are connected with each other via the home LAN 30. It is assumed that the above-described pairing process between the controller 10 and the radio processing device 20 has already been carried out.

Note here that the controller 10 is not allowed to control operation of the radio processing device 20 in a case where the controller 10 and the radio processing device 20 are connected with each other via the home LAN 30 in a state where the pairing process between the controller 10 and the radio processing device 20 has not been carried out.

In this case, as an error process, the controller 10 causes a non-illustrated display section to display an error message. One example of the error message can be as follows: “The radio processing device 20 is not found. Please check the connection and the power source of the radio processing device 20 and restart the radio processing device 20. If there is no problem, please make direct connection with the radio processing device 20 and restart the radio processing device 20.”

In the sequence diagram shown in FIG. 5, the controller 10 is first powered on by the user (sequence S11). After sequence S11, the controller 10 broadcasts, via the home LAN 30 connected with the communication connector 15, a search packet requesting a response from the radio processing device 20 (sequence S12).

It is assumed that communication between the controller 10 and the radio processing device 20 in the authentication process is carried out according to a user datagram protocol (UDP). However, this is not limitative. The search packet includes the serial number of the controller 10.

Subsequently, in sequence S13, the second communication control section 21 of the radio processing device 20 determines that the search packet supplied from the controller 10 has been received via the second communication connector 28.

After sequence S13, the radio processing device 20 transmits a response packet as a response to the search packet (sequence S14). The response packet includes connection information indicating that the search packet has been received by the second communication connector 28. The response packet further includes second identification information, which is identification information of the radio processing device 20, and a random character string.

After sequence S14, the first communication control section 11 of the controller 10 receives the response packet from the radio processing device 20, and determines, on the basis of the connection information included in the received response packet, whether the connection is made via the first communication connector 27 or via the second communication connector 28 (sequence S15: determination step).

Then, in a case where the response packet includes the connection information indicating that the connection is made via the second communication connector 28 and the second identification information included in the response packet is identical to the second communication target identification information (sequence S16), the first communication control section 11 carries out communication with the radio processing device 20 which has transmitted the response packet.

After sequence S16, the first communication control section 11 transmits a power-ON start packet to the radio processing device 20 (sequence S17). The power-ON start packet includes the serial number of the controller 10, data obtained by encrypting a hash value of the random character string with the secret key, and the public key stored in the first memory 13.

After sequence S17, the second communication control section 21 receives the power-ON start packet and checks the cipher (sequence S18). To be more specific, the second communication control section 21 decrypts the encrypted hash value with the public key of the communication target (hereinafter, such a public key will be referred to as a “communication target public key”) stored in the second memory 23; then, the second communication control section 21 compares the decrypted hash value with the hash value of the random character string generated by the second communication control section 21, and checks whether or not these hash values are identical to each other. If these hash values are identical to each other, the second communication control section 21 recognizes that the controller 10 has been authenticated.

After sequence S18, in a case where communication using the communication target public key is successfully carried out and consequently it is confirmed that the radio processing device 20 has been authenticated, the second communication control section 21 transmits, to the radio processing device 20, an instruction to bring the signal processing section 22 into a state in which power is supplied to the signal processing section 22, so that the signal processing section 22 is powered on (sequence S19). Note that sequences S16 to S19 correspond to the control step, which carries out a process on the basis of a determination result obtained in the determination step.

As discussed above, in a case where the radio processing device 20 is connected, via the home LAN 30, with the controller 10 having been paired therewith, when reliable determination of whether or not the controller 10 is authenticated is made and the signal processing section 22 is powered on, a process on a high frequency signal transmitted or received via the antenna 25 becomes ready to be carried out. This makes it possible for the controller 10 to control operation of the radio processing device 20 via the home LAN 30.

### Effects of Embodiments

As discussed above, according to the radio communication system 1 in accordance with the present embodiment, the controller 10 and the radio processing device 20 are separated from each other, and it is possible to automatically change process content depending on whether connection between the controller 10 and the radio processing device 20 is direct connection made by the communication cable 51 (see FIG. 1) or connection made via the home LAN 30 (see FIG. 4). To be more specific, the process content in sequences S6 to S9 in FIG. 2 is made different from the process content in sequences S16 to S19 in FIG. 5. Consequently, it is possible to carry out communication appropriate for the connection mode.

Further, in a case where the response packet includes the connection information indicating that the connection is made via the first communication connector 27, the first communication control section 11 stores, in the first memory 13, the second identification information included in the response packet, as the second communication target identification information indicative of the communication target radio processing device. The second communication control section 21 stores, in the second memory 23, the first identification information included in the power-ON start packet received via the first communication connector 27, as first identification information of the communication target (hereinafter, such identification information will be referred to as “first communication target identification information”) indicative of a controller which is the communication target (hereinafter, such a controller will be referred to as a “communication target controller”).

As described above, merely by directly connecting the controller 10 with the radio processing device 20 by the communication cable 51 via the first communication connector 27 at the first stage, it is possible to carry out the pairing process so as to (a) set the controller 10 as the communication target of the radio processing device 20 and (b) set the radio processing device 20 as the communication target of the controller 10. This makes it possible for the user to use the radio communication system 1 in a simple manner. That is, the user can use the radio communication system 1 after powering on the controller 10, even without carrying out troublesome setting operation such as setting of a unique password and/or a unique ID.

Furthermore, on the basis of the connection information included in the response packet transmitted in sequence S4 or S14, the first communication control section 11 determines whether the connection is made via the first communication connector 27 or via the second communication connector 28 (sequence S5 or S15: determination step). With this, the controller 10 can accurately and easily check whether the connection with the radio processing device 20 is direct connection or connection made via the home LAN 30.

Moreover, in a case where the response packet includes the connection information indicating that the connection is made via the second communication connector 28 and the second identification information included in the response packet is identical to the second communication target identification information, the first communication control section 11 carries out communication with the radio processing device 20 which has transmitted the response packet. With this, when the controller 10 is connected, via the home LAN 30, with a radio processing device 20 with which the controller 10 has been connected in the past, the controller 10 can immediately start communication with that radio processing device 20.

### Other Embodiments

In the foregoing embodiments, the radio communication system 1 includes one radio processing device 20. However, this is not limitative. Alternatively, the radio communication system 1 may include a plurality of radio processing devices 20.

In this case, when the controller 10 is powered on, first, the controller 10 preferentially selects, as a connection destination, a radio processing device 20 which is directly connected with the controller 10 via the first communication connector 27; thereafter, the controller 10 selects, as a connection destination, a radio processing device 20 having been paired therewith. With this, the controller 10 can quickly selects, from among the plurality of radio processing devices 20, a radio processing device 20 which is a communication target. This makes it possible to prevent the controller 10 from carrying out communication with a radio processing device 20 having not been paired therewith.

Further, in the foregoing embodiments, the controller 10 includes one memory serving as the first memory 13. However, this is not limitative. The controller 10 may include a plurality of memories. In this case, the functions of the sections of the controller 10 may be realized by causing the plurality of memories to work together.

Furthermore, in the foregoing explanation, the radio processing device 20 includes one CPU serving as the second communication control section 21. However, this is not limitative. Alternatively, the radio processing device 21 may include a plurality of CPUs. In this case, the functions of the sections of the radio processing device 20 may be realized by causing the plurality of CPUs to work together.

### Software Implementation Example

The functions of the radio processing device 20 (hereinafter referred to as a “device”) can be realized by a program for causing a computer to function as the device, the program causing the computer to function as the control blocks (the second communication control section 21 and the signal processing section 22) of the device.

In this case, the device includes, as hardware for executing the program, a computer that includes at least one control device (e.g., a processor) and at least one storage device (e.g., a memory). The control device and the storage device execute the program, so that the functions described in the above embodiments are realized.

The program may be recorded in one or more non-transitory computer-readable recording media. The one or more recording media may or may not be included in the device. In the latter case, the program can be supplied to the device via any wired or wireless transmission medium.

Alternatively, a part or all of the functions of the control blocks can be realized by a logic circuit. For example, the present invention encompasses, in its scope, an integrated circuit in which a logic circuit that functions as each of the control blocks is formed. In addition, the function of each of the control blocks can be realized by, for example, a quantum computer.

Further, each of the processes described in the above embodiments can be executed by artificial intelligence (AI). In this case, the AI may be operated by the control device or may be operated by another device (for example, an edge computer and a cloud server).

The present disclosure is not limited to the embodiments described above, but can be altered within the scope of the claims. The present invention also encompasses, in its technical scope, any embodiment derived by combining technical means disclosed in differing embodiments.

### REFERENCE SIGNS LIST

1: radio communication system
10: controller
11: first communication control section
20: radio processing device
21: second communication control section
22: signal processing section
25: antenna
51: communication cable
52: communication cable

1. A communication system comprising:
a communication processing device; and
a controller which is communicably connected with the communication processing device, the controller being configured to control operation of the communication processing device,
the communication processing device including
a second communication control section configured to carry out communication with the controller,
the controller including
a first communication control section configured (a) to determine, after the controller starts communication with the communication processing device, whether the connection between the controller and the communication processing device is direct connection made by a communication cable or connection made via a communication network and (b) to carry out a process according to a result of the determination.

2. The communication system according to claim 1, wherein
the communication processing device is a radio processing device configured to process a high frequency signal transmitted or received via an antenna.

3. The communication system according to claim 1, wherein
the communication processing device includes a first communication connector and a second communication connector, the first communication connector being to be used to make direct connection with the controller by the communication cable, and the second communication connector being to be used to make connection with the controller via the communication network,
the first communication control section is further configured to determine whether the connection between the controller and the communication processing device is made via the first communication connector or via the second communication connector,
in a case where the connection is made via the first communication connector, the first communication control section determines that the connection between the controller and the communication processing device is direct connection made by the communication cable, and
in a case where the connection is made via the second communication connector, the first communication control section determines that the connection between the controller and the communication processing device is connection made via the communication network.

4. The communication system according to claim 3, wherein
at a time when the controller starts communication in response to power-on of the controller, the first communication control section broadcasts a search packet for searching the communication processing device,
the second communication control section transmits, as a response to the search packet, a response packet including connection information indicating whether the search packet has been received via the first communication connector or via the second communication connector, and
the first communication control section determines, on a basis of the connection information included in the response packet, whether the connection is made via the first communication connector or via the second communication connector.

5. The communication system according to claim 4, wherein
the second communication control section transmits the response packet including second identification information, which is identification information of the communication processing device,
in a case where the response packet includes connection information indicating that the connection is made via the first communication connector, the first communication control section stores, as second communication target identification information indicative of a communication target communication processing device, the second identification information included in the response packet, and transmits a power-ON start packet including first identification information which is identification information of the controller, and
the second communication control section stores, as first communication target identification information indicative of a communication target controller, the first identification information thus received.

6. The communication system according to claim 5, wherein
in a case where the response packet includes connection information indicating that the connection is made via the second communication connector and the second identification information included in the response packet is identical to the second communication target identification information, the first communication control section carries out communication with the communication processing device which has transmitted the response packet.

7. The communication system according to claim 5, wherein
the power-ON start packet includes a public key,
the second communication control section stores, as a communication target public key, the public key that the second communication control section has received, and
in a case where the second communication control section receives the search packet via the second communication connector and communication with the controller which has transmitted the search packet is carried out successfully by using the communication target public key, the second communication control section caries out communication with the controller which has transmitted the search packet.

8. The communication system according to claim 2, wherein
the communication processing device further includes a signal processing section which processes the high frequency signal,
the communication processing device is further configured to be on standby in a state where the communication processing device is communicable with the controller (a) with power being supplied to the second communication control section and (b) with no power being supplied to the signal processing section, and
in a case where the controller starts communication in response to power-on of the controller and the communication processing device is confirmed as a communication target, the second communication control section transmits, to the communication processing device, an instruction to bring the signal processing section into a state in which power is supplied to the signal processing section.

9. A controller included in a communication system recited in claim 1.

10. A communication processing device included in a communication system recited in claim 1.

11. A method for controlling a communication system which includes a communication processing device and a controller which is communicably connected with the communication processing device, the controller being configured to control operation of the communication processing device, the control method comprising:
a determination step of determining, after the controller starts communication with the communication processing device, whether the connection between the controller and the communication processing device is direct connection made by a communication cable or connection made via a communication network; and
a control step of carrying out a process according to a result of the determination made in the determination step.
